(19) United States
(12) Patent Application Publication
(10) Pub. No.: US 2024/0032577 A1
(43) Pub. Date: Feb. 1, 2024

(54) Method For Producing Red Seasoning

(71) Applicant: BOMCHOYEO Agricultural Company Corporation, Nonsan-si (KR)

(72) Inventor: Jeong Suk BAE, Nonsan-si (KR)

(73) Assignee: BOMCHOYEO Agricultural Company Corporation, Nonsan-si (KR)

(21) Appl. No.: 17/963,205

(22) Filed: Oct. 11, 2022

(30) Foreign Application Priority Data
Jul. 29, 2022 (KR) 10-2022-0094319

(51) Int. Cl. A23L 27/12; A23L 27/10; A23L 7/25; A23L 29/30; A23L 17/20; A23L 19/20

(52) U.S. Cl. CPC A23L 27/13; A23L 27/105; A23L 7/25; A23L 29/30; A23L 17/20; A23L 19/20

(57) ABSTRACT

The present invention relates to a method for producing a strawberry pepper seasoning produced using an anchovy sauce, malted rice and rice syrup and a strawberry fermented solution for added tastes instead of salt, fermented soybean powder, and malt, which have been generally used in the production of red pepper paste, and a strawberry pepper seasoning produced by the method.

### TECHNICAL FIELD

The present invention relates to a method for producing a strawberry pepper seasoning and a strawberry pepper seasoning produced by the method, characterized by preparing a strawberry pulverized product by aging, freeze-drying, and pulverizing a strawberry mixture in which a strawberry fermented solution, malted rice, a garlic pulverized product, rice syrup and an anchovy sauce are mixed; and mixing red pepper powder with the prepared strawberry pulverized product.

### BACKGROUND ART

In general, red pepper paste is one of the soy sauces, and is made by mixing and then aging powdered fermented soybeans, red pepper powder, and other ingredients and contains nutrients such as proteins, sugars, carotene, vitamins, capsaicin, and soybean peptides, and physiologically active substances and has a characteristic of harmonizing spicy, sweet, and savory taste.

There are traditional and improved manufacturing methods of red pepper paste, and the traditional method is to mix all ingredients and then ferment the mixture with Bacillus subtilis. Traditional red pepper paste has a deep taste, but the red color fades during fermentation to turn to dark red. The improved red pepper paste is added with red pepper powder before commercialization after mixing and fermenting raw materials except red pepper powder. Accordingly, although the color is red and fine, a deep taste lacks.

All of these red pepper paste manufacturing methods are a saccharification method of starch, which is saccharified with enzymes obtained by culturing bacteria or fungi. However, there is a method for manufacturing directly using an enzyme of malt without culturing the bacteria, which is a simple manufacturing method in which glutinous rice powder is mixed with a malt liquid, the fermented liquid is boiled, and then fermented soybean powder, red pepper powder and salt are mixed by quantity, and then naturally aged.

Salad is a typical vegetable recipe and gives a fresh feeling, stimulates appetite, and is rich in vitamins and minerals. Thus, recently, the consumption of dressings and sauces to accompany salads as well as salads using various vegetables has been increased by consumers who have increased interest in health.

In Korean Patent Registration No. 2397024, there is disclosed a kimchi taste powdered natural salad seasoning, and in Korean Patent Publication No. 2014-0075098, there is disclosed a composition for preparing a powdered dressing and a method for preparing the same, but there is a difference from the method for producing the red seasoning of the present invention.

### DISCLOSURE

### Technical Problem

The present invention has been derived by these demands, and an object of the present invention is to provide a strawberry pepper seasoning using strawberries, malted rice, rice syrup, red pepper powder, and the like, in which the food added with the seasoning may be enjoyed with a delicious taste. The present inventors developed a strawberry pepper seasoning that has excellent taste and flavor and is suitable for the taste of Koreans and then completed the present invention.

### Technical Solution

To solve the problem, the present invention provides a method for producing a strawberry pepper seasoning including the steps of: preparing a strawberry mixed fermented solution by mixing a strawberry fermented solution, a radish fermented solution and an onion fermented solution; preparing malted rice by spreading rice straw in a fermentation chamber, putting and fermenting rice paste thereon, and drying, pulverizing, and molding the rice paste; preparing a garlic pulverized product by putting and heating garlic in a steamer, and then pulverizing the garlic; preparing rice syrup by adding malt and water to rice cooked with rice, saccharifying and filtering the mixture, and then boiling a filtered saccharification solution; preparing a strawberry pulverized product by aging and then freeze-drying and pulverizing a strawberry mixture mixed with the prepared strawberry mixed fermented solution, the prepared malted rice, the prepared garlic pulverized product, the prepared rice syrup, and the anchovy sauce; and mixing red pepper powder, basil powder and black pepper powder with the prepared strawberry pulverized product.

The present invention also provides a strawberry pepper seasoning produced by the method.

### Advantageous Effects

According to the present invention, instead of salt, fermented soybean powder, and malt used in the production of red pepper paste, which had a salty taste and unpleasant odor, the strawberry pepper seasoning produced using an anchovy sauce, malted rice and rice syrup and a strawberry fermented solution for added tastes enhances a fresh taste, a savory taste and a flavor to have an effect of enhancing the taste of food when used for food. In addition, it is possible to provide consumers with eco-friendly taste and health-oriented high value-added seasoning in conventional seasonings containing artificial synthetic additives on the market.

### MODES FOR THE INVENTION

In order to achieve an object of the present invention, the present invention provides a method for producing a strawberry pepper seasoning including the steps of:
(1) preparing a strawberry fermented solution by fermenting a mixture of strawberries with sugar and salt, and then filtering and aging the mixture;
(2) preparing a radish fermented solution by fermenting a mixture of radish with sugar, salt, citric acid, and pine needles, and then filtering the mixture;
(3) preparing an onion fermented solution by fermenting a mixture of onion with sugar, salt, and lime juice, and then filtering the mixture;
(4) preparing a strawberry mixed fermented solution by mixing the strawberry fermented solution prepared in step (1), the radish fermented solution prepared in step (2), and the onion fermented solution prepared in step (3);
(5) preparing malted rice by spreading rice straw in a fermentation chamber, putting and fermenting rice paste thereon, and drying, pulverizing, and molding the rice paste;
(6) preparing a garlic pulverized product by putting and heating garlic in a steamer, and then pulverizing the garlic;
(7) preparing rice syrup by adding malt and water to rice cooked with rice, saccharifying and filtering the mixture, and then boiling a filtered saccharification solution;
(8) preparing a strawberry pulverized product by aging and then freeze-drying and pulverizing a strawberry mixture mixed with the strawberry mixed fermented solution prepared in step (4), the malted rice prepared in step (5), the garlic pulverized product prepared in step (6), the rice syrup prepared in step (7), and the anchovy sauce; and
(9) mixing red pepper powder, basil powder and black pepper powder with the strawberry pulverized product prepared in step (8).

In the method for producing the strawberry pepper seasoning of the present invention, the strawberry fermented solution of step (1) may be preferably prepared by fermenting a mixture mixed with 67 to 71 wt % of strawberries, 28 to 32 wt % of sugar, and 0.5 to 1.5 wt % of salt based on the total weight of the mixture at 20 to 30° C. for 25 to 35 days, filtering the mixture, and then aging at 12 to 17° C., more preferably prepared by fermenting a mixture mixed with 69 wt % of strawberries, 30 wt % of sugar, and 1 wt % of salt based on the total weight of the mixture at 20 to 30° C. for 30 days, filtering the mixture, and then aging at 12 to 17° C. When an appropriate amount of the strawberry fermented solution prepared under the conditions is added during seasoning production, it was able to harmonize well with a taste of the seasoning and enhance savory and deep tastes.

In addition, in the method for producing the strawberry pepper seasoning of the present invention, the radish fermented solution of step (2) may be preferably prepared by fermenting a mixture mixed with 57 to 61 wt % of radish, 33 to 37 wt % of sugar, 4 to 6 wt % of salt, 0.3 to 0.7 wt % of citric acid, and 0.3 to 0.7 wt % of pine needles based on the total weight of the mixture at 20 to 30° C. for 80 to 100 days, and then filtering the mixture, more preferably prepared by fermenting a mixture mixed with 59 wt % of radish, 35 wt % of sugar, 5 wt % of salt, 0.5 wt % of citric acid, and 0.5 wt % of pine needles based on the total weight of the mixture at 20 to 30° C. for 90 days, and then filtering the mixture.

In addition, in the method for producing the strawberry pepper seasoning of the present invention, the onion fermented solution of step (3) may be preferably prepared by fermenting a mixture mixed with 61 to 65 wt % of onion, 31 to 35 wt % of sugar, 2 to 4 wt % of salt, and 0.6 to 1.0 wt % of lime juice based on the total weight of the mixture at 20 to 30° C. for 50 to 70 days, and then filtering the mixture, more preferably prepared by fermenting a mixture mixed with 63.2 wt % of radish, 33 wt % of sugar, 3 wt % of salt, and 0.8 wt % of lime juice based on the total weight of the mixture at 20 to 30° C. for 60 days, and then filtering the mixture.

In addition, in the method for producing the strawberry pepper seasoning of the present invention, the strawberry mixed fermented solution of step (4) may be preferably prepared by mixing the strawberry fermented solution, the radish fermented solution and the onion fermented solution at a weight ratio of 3.5 to 4.5:4.5 to 5.5:0.5 to 1.5, more preferably prepared by mixing the strawberry fermented solution, the radish fermented solution and the onion fermented solution at a weight ratio of 4:5:1.

In addition, in the method for producing the strawberry pepper seasoning of the present invention, the malted rice of step (5) may be preferably prepared by spreading rice straw in the fermentation chamber, putting the rice paste thereon, fermenting the rice paste at 28 to 32° C. for 6 to 8 days, drying at 20 to 25° C. for 2 to 4 days, and then pulverizing and molding the rice paste, more preferably prepared by spreading rice straw in the fermentation chamber, putting the rice paste thereon, fermenting the rice paste at 30° C. for 7 days, drying at 20 to 25° C. for 3 days, and then pulverizing and molding the rice paste.

In addition, in the method for producing the strawberry pepper seasoning of the present invention, the garlic pulverized product of step (6) may be preferably prepared by putting the garlic in the steamer, heating at 95 to 105° C. for 10 to 15 minutes and then pulverizing the garlic, more preferably prepared by putting the garlic in the steamer, heating at 100° C. for 10 to 15 minutes and then pulverizing the garlic. By heating the garlic under the conditions as described above, it is possible to prepare a pulverized product in which the peculiar odor and the spicy taste of garlic are reduced and the sweet taste is enhanced.

In addition, in the method for producing the strawberry pepper seasoning of the present invention, the rice syrup of step (7) may be preferably prepared by adding 80 to 120 g of malt and 2.4 to 2.8 L of water to rice cooked with 0.8 to 1.2 kg of rice, saccharifying at 55 to 60° C. for 7 to 11 hours and filtering the mixture, and then boiling the filtered saccharification solution at 90 to 100° C. to prepare rice syrup of 60 to 70 brix, more preferably prepared by adding 100 g of malt and 2.6 L of water to rice cooked with 1 kg of rice, saccharifying at 55 to 60° C. for 9 hours and filtering the mixture, and then boiling the filtered saccharification solution at 95° C. to prepare rice syrup of 65 brix. The rice syrup prepared under the conditions has a unique soft and sticky taste of the syrup and is shiny, and when an appropriate amount is added to the seasoning, the taste and flavor of seasoning are better than those of syrup prepared by other sugars under other conditions.

In addition, in the method for producing the strawberry pepper seasoning of the present invention, the strawberry pulverized product of step (8) may be preferably prepared by aging the strawberry mixture mixed with 23 to 27 parts by weight of the strawberry mixed fermented solution, 7 to 9 parts by weight of the malted rice, 7 to 9 parts by weight of the garlic pulverized product, 16 to 20 parts by weight of the rice syrup, and 18 to 22 parts by weight of the anchovy sauce at 20 to 30° C. for 2 to 4 months, and then freeze-drying and pulverizing the mixture, more preferably prepared by aging the strawberry mixture mixed with 25 parts by weight of the strawberry mixed fermented solution, 8 parts by weight of the malted rice, 8 parts by weight of the garlic pulverized product, 18 parts by weight of the rice syrup, and 20 parts by weight of the anchovy sauce at 20 to 30° C. for 3 months, and then freeze-drying and pulverizing the mixture. The strawberry pulverized product prepared by mixing and then aging the materials prepared under the conditions may be prepared as a strawberry pulverized product with excellent flavor because a sweet taste, a fresh taste, and a savory taste are well harmonized.

In addition, in the method for producing the strawberry pepper seasoning of the present invention, step (9) may be preferably mixing the red pepper powder, the basil powder and the black pepper powder with the strawberry pulverized product at a weigh ratio of 77 to 81:17 to 21:0.5 to 1.5:0.5 to 1.5, more preferably mixing the red pepper powder, the basil powder and the black pepper powder with the strawberry pulverized product at a weigh ratio of 79:19:1:1. By mixing in the same ratio as above, it is possible to prepare a seasoning in which a spicy taste and a savory taste are added to further stimulate the appetite.

The method for producing the strawberry pepper seasoning of the present invention may more particularly include the steps of:
(1) preparing a strawberry fermented solution by fermenting a mixture mixed with 67 to 71 wt % of strawberries, 28 to 32 wt % of sugar, and 0.5 to 1.5 wt % of salt based on the total weight of the mixture at 20 to 30° C. for 25 to 35 days, filtering the mixture, and then aging at 12 to 17° C.;
(2) preparing a radish fermented solution by fermenting a mixture mixed with 57 to 61 wt % of radish, 33 to 37 wt % of sugar, 4 to 6 wt % of salt, 0.3 to 0.7 wt % of citric acid, and 0.3 to 0.7 wt % of pine needles based on the total weight of the mixture at 20 to 30° C. for 80 to 100 days, and then filtering the mixture;
(3) preparing an onion fermented solution by fermenting a mixture mixed with 61 to 65 wt % of onion, 31 to 35 wt % of sugar, 2 to 4 wt % of salt, and 0.6 to 1.0 wt % of lime juice based on the total weight of the mixture at 20 to 30° C. for 50 to 70 days, and then filtering the mixture;
(4) preparing a strawberry mixed fermented solution by mixing the strawberry fermented solution prepared in step (1), the radish fermented solution prepared in step (2) and the onion fermented solution prepared in step (3) at a weight ratio of 3.5 to 4.5:4.5 to 5.5:0.5 to 1.5;
(5) preparing malted rice by spreading rice straw in a fermentation chamber, putting rice paste thereon, fermenting the rice paste at 28 to 32° C. for 6 to 8 days, drying at 20 to 25° C. for 2 to 4 days, and then pulverizing and molding the rice paste;
(6) preparing a garlic pulverized product by putting garlic in a steamer, heating at 95 to 105° C. for 10 to 15 minutes and then pulverizing the garlic;
(7) preparing rice syrup of 60 to 70 brix by adding 80 to 120 g of malt and 2.4 to 2.8 L of water to rice cooked with 0.8 to 1.2 kg of rice, saccharifying at 55 to 60° C. for 7 to 11 hours and filtering the mixture, and then boiling the filtered saccharification solution at 90 to 100° C.;
(8) preparing a strawberry pulverized product by aging the strawberry mixture mixed with 23 to 27 parts by weight of the strawberry mixed fermented solution prepared in step (4), 7 to 9 parts by weight of the malted rice prepared in step (5), 7 to 9 parts by weight of the garlic pulverized product prepared in step (6), 16 to 20 parts by weight of the rice syrup prepared in step (7), and 18 to 22 parts by weight of the anchovy sauce at 20 to 30° C. for 2 to 4 months, and then freeze-drying and pulverizing the mixture; and
(9) mixing red pepper powder, basil powder and black pepper powder with the strawberry pulverized product prepared in step (8) at a weigh ratio of 77 to 81:17 to 21:0.5 to 1.5:0.5 to 1.5.

More specifically, the method for producing the strawberry pepper seasoning of the present invention may include the steps of:
(1) preparing a strawberry fermented solution by fermenting a mixture mixed with 69 wt % of strawberries, 30 wt % of sugar, and 1 wt % of salt based on the total weight of the mixture at 20 to 30° C. for 30 days, filtering the mixture, and then aging at 12 to 17° C.;
(2) preparing a radish fermented solution by fermenting a mixture mixed with 59 wt % of radish, 35 wt % of sugar, 5 wt % of salt, 0.5 wt % of citric acid, and 0.5 wt % of pine needles based on the total weight of the mixture at 20 to 30° C. for 90 days, and then filtering the mixture;
(3) preparing an onion fermented solution by fermenting a mixture mixed with 63.2 wt % of onion, 33 wt % of sugar, 3 wt % of salt, and 0.8 wt % of lime juice based on the total weight of the mixture at 20 to 30° C. for 60 days, and then filtering the mixture;
(4) preparing a strawberry mixed fermented solution by mixing the strawberry fermented solution prepared in step (1), the radish fermented solution prepared in step (2), and the onion fermented solution prepared in step (3) at a weight ratio of 4:5:1;
(5) preparing malted rice by spreading rice straw in a fermentation chamber, putting rice paste thereon, fermenting the rice paste at 30° C. for 7 days, drying at 20 to 25° C. for 3 days, and then pulverizing and molding the rice paste;
(6) preparing a garlic pulverized product by putting garlic in a steamer, heating at 100° C. for 10 to 15 minutes and then pulverizing the garlic;
(7) preparing rice syrup of 65 brix by adding 100 g of malt and 2.6 L of water to rice cooked with 1 kg of rice, saccharifying at 55 to 60° C. for 9 hours and filtering the mixture, and then boiling the filtered saccharification solution at 95° C.;
(8) preparing a strawberry pulverized product by aging the strawberry mixture mixed with 25 parts by weight of the strawberry mixed fermented solution prepared in step (4), 8 parts by weight of the malted rice prepared in step (5), 8 parts by weight of the garlic pulverized product prepared in step (6), 18 parts by weight of the rice syrup prepared in step (7), and 20 parts by weight of the anchovy sauce at 20 to 30° C. for 3 months, and then freeze-drying and pulverizing the mixture; and
(9) mixing red pepper powder, basil powder and black pepper powder with the strawberry pulverized product prepared in step (8) at a weigh ratio of 79:19:1:1.

In the method for producing the strawberry pepper seasoning of the present invention, when preparing the malted rice and the rice syrup, additional materials are further used to enhance the flavor and taste of the seasoning, but more specifically, the method may include the steps of:
(1) preparing a strawberry fermented solution by fermenting a mixture mixed with 67 to 71 wt % of strawberries, 28 to 32 wt % of sugar, and 0.5 to 1.5 wt % of salt based on the total weight of the mixture at 20 to 30° C. for 25 to 35 days, filtering the mixture, and then aging at 12 to 17° C.;
(2) preparing a radish fermented solution by fermenting a mixture mixed with 57 to 61 wt % of radish, 33 to 37 wt % of sugar, 4 to 6 wt % of salt, 0.3 to 0.7 wt % of citric acid, and 0.3 to 0.7 wt % of pine needles based on the total weight of the mixture at 20 to 30° C. for 80 to 100 days, and then filtering the mixture;
(3) preparing an onion fermented solution by fermenting a mixture mixed with 61 to 65 wt % of onion, 31 to 35 wt % of sugar, 2 to 4 wt % of salt, and 0.6 to 1.0 wt % of lime juice based on the total weight of the mixture at 20 to 30° C. for 50 to 70 days, and then filtering the mixture;
(4) preparing a strawberry mixed fermented solution by mixing the strawberry fermented solution prepared in step (1), the radish fermented solution prepared in step (2) and the onion fermented solution prepared in step (3) at a weight ratio of 3.5 to 4.5:4.5 to 5.5:0.5 to 1.5;
(5) preparing malted rice by spreading rice straw in a fermentation chamber, spreading raspberry leaves and vitamin tree leaves sequentially thereon, putting rice paste on the vitamin tree leaves, fermenting the rice paste at 28 to 32° C. for 6 to 8 days, drying at 20 to 25° C. for 2 to 4 days, and then pulverizing and molding the rice paste;
(6) preparing a garlic pulverized product by putting garlic in a steamer, heating at 95 to 105° C. for 10 to 15 minutes and then pulverizing the garlic;
(7) preparing rice syrup of 60 to 70 brix by adding 80 to 120 g of malt and 2.4 to 2.8 L of water to rice cooked with 0.8 to 1.2 kg of rice, saccharifying at 55 to 60° C. for 7 to 11 hours and filtering the mixture, and then adding 0.8 to 1.2% (w/v) of fig leaf powder and 0.8 to 1.2% (w/v) of savory powder based on the saccharification solution to the filtered saccharification solution, and boiling the mixture at 90 to 100° C.;
(8) preparing a strawberry pulverized product by aging the strawberry mixture mixed with 23 to 27 parts by weight of the strawberry mixed fermented solution prepared in step (4), 7 to 9 parts by weight of the malted rice prepared in step (5), 7 to 9 parts by weight of the garlic pulverized product prepared in step (6), 16 to 20 parts by weight of the rice syrup prepared in step (7), and 18 to 22 parts by weight of the anchovy sauce at 20 to 30° C. for 2 to 4 months, and then freeze-drying and pulverizing the mixture; and
(9) mixing red pepper powder, basil powder and black pepper powder with the strawberry pulverized product prepared in step (8) at a weigh ratio of 77 to 81:17 to 21:0.5 to 1.5:0.5 to 1.5.

More specifically, the method for producing the strawberry pepper seasoning of the present invention may include the steps of:
(1) preparing a strawberry fermented solution by fermenting a mixture mixed with 69 wt % of strawberries, 30 wt % of sugar, and 1 wt % of salt based on the total weight of the mixture at 20 to 30° C. for 30 days, filtering the mixture, and then aging at 12 to 17° C.;
(2) preparing a radish fermented solution by fermenting a mixture mixed with 59 wt % of radish, 35 wt % of sugar, 5 wt % of salt, 0.5 wt % of citric acid, and 0.5 wt % of pine needles based on the total weight of the mixture at 20 to 30° C. for 90 days, and then filtering the mixture;
(3) preparing an onion fermented solution by fermenting a mixture mixed with 63.2 wt % of onion, 33 wt % of sugar, 3 wt % of salt, and 0.8 wt % of lime juice based on the total weight of the mixture at 20 to 30° C. for 60 days, and then filtering the mixture;
(4) preparing a strawberry mixed fermented solution by mixing the strawberry fermented solution prepared in step (1), the radish fermented solution prepared in step (2), and the onion fermented solution prepared in step (3) at a weight ratio of 4:5:1;
(5) preparing malted rice by spreading rice straw in a fermentation chamber, spreading raspberry leaves and vitamin tree leaves sequentially thereon, putting rice paste on the vitamin tree leaves, fermenting the rice paste at 30° C. for 7 days, drying at 20 to 25° C. for 3 days, and then pulverizing and molding the rice paste;
(6) preparing a garlic pulverized product by putting garlic in a steamer, heating at 100° C. for 10 to 15 minutes and then pulverizing the garlic;
(7) preparing rice syrup of 65 brix by adding 100 g of malt and 2.6 L of water to rice cooked with 1 kg of rice, saccharifying at 55 to 60° C. for 9 hours and filtering the mixture, and then adding 1% (w/v) of fig leaf powder and 1% (w/v) of savory powder based on the saccharification solution to the filtered saccharification solution, and boiling the mixture at 95° C.;
(8) preparing a strawberry pulverized product by aging the strawberry mixture mixed with 25 parts by weight of the strawberry mixed fermented solution prepared in step (4), 8 parts by weight of the malted rice prepared in step (5), 8 parts by weight of the garlic pulverized product prepared in step (6), 18 parts by weight of the rice syrup prepared in step (7), and 20 parts by weight of the anchovy sauce at 20 to 30° C. for 3 months, and then freeze-drying and pulverizing the mixture; and
(9) mixing red pepper powder, basil powder and black pepper powder with the strawberry pulverized product prepared in step (8) at a weigh ratio of 79:19:1:1.

The present invention also provides a strawberry pepper seasoning produced by the method.

Hereinafter, Preparation Examples and Examples of the present invention will be described in detail. However, the following Preparation Examples and Examples are just illustrative of the present invention, and the contents of the present invention are not limited to the following Preparation Examples and Examples.

### Preparation Example 1. Strawberry Pepper (Red) Seasoning

(1) A strawberry fermented solution was prepared by fermenting a mixture mixed with 69 wt % of washed Nonsan strawberries, 30 wt % of sugar, and 1 wt % of sea salt based on the total weight of the mixture in a pot at 20 to 30° C. for 30 days, filtering the mixture, and then aging at 12 to 17° C. for 1 year.

(2) A radish fermented solution was prepared by fermenting a mixture mixed with 59 wt % of crushed radish, 35 wt % of sugar, 5 wt % of sea salt, 0.5 wt % of citric acid, and 0.5 wt % of pine needles based on the total weight of the mixture in a pot at 20 to 30° C. for 90 days, and then filtering the mixture.

(3) An onion fermented solution was prepared by fermenting a mixture mixed with 63.2 wt % of chopped onion, 33 wt % of sugar, 3 wt % of sea salt, and 0.8 wt % of lime juice based on the total weight of the mixture in a pot at 20 to 30° C. for 60 days, and then filtering the mixture.

(4) A strawberry mixed fermented solution was prepared by mixing the strawberry fermented solution prepared in step (1), the radish fermented solution prepared in step (2), and the onion fermented solution prepared in step (3) at a weight ratio of 4:5:1.

(5) Domestic rice flour was sprayed with about 15 to 20% (v/w) of water based on rice flour, kneaded, and then molded into a round shape with a diameter of 5 to 15 cm. Malted rice was prepared by spreading rice straw in a fermentation chamber, putting the molded rice paste thereon and covering a cotton cloth thereon, fermenting the rice paste at 30° C. for 7 days while turning over once a day, drying in the shade at 20 to 25° C. for 3 days, sweeping clearly, crushing, molding in the sunlight for about 3 to 4 days, and then pulverizing the rice paste.

(6) Domestic garlic was peeled, washed thoroughly, put on a sieve of a steamer, heated at 100° C. for 10 to 15 minutes, taken out, and grinded with a blender to prepare a garlic pulverized product.

(7) An anchovy sauce was prepared by purchasing anchovies from Hongwon Port and nearby seas in Seocheon, first aging an anchovy mixture with a salinity of about 20 to 25% mixed with sea salt without salt in an aging tank at 20 to 25° C. for 36 months or more, and then extracting only the liquid, and second aging and precipitating the anchovy liquid at 5° C. for 6 months.

(8) Rice syrup of 65 brix was prepared by adding 100 g of malt and 2.6 L of water to rice cooked with 1 kg of rice, saccharifying at 55 to 60° C. for 9 hours and filtering the mixture, and then boiling the filtered saccharification solution at 95° C.

(9) A strawberry pulverized product was prepared by aging the strawberry mixture mixed with 25 parts by weight of the strawberry mixed fermented solution prepared in step (4), 8 parts by weight of the malted rice prepared in step (5), 8 parts by weight of the garlic pulverized product prepared in step (6), 20 parts by weight of the anchovy sauce prepared in step (7), and 18 parts by weight of the rice syrup prepared in step (8) in a fermentation tank at 20 to 30° C. for 3 months, and then freeze-drying and pulverizing the mixture.

(10) Domestic red pepper powder, basil powder and black pepper powder were mixed with the strawberry pulverized product prepared in step (9) at a weight ratio of 79:19:1:1.

### Preparation Example 2. Strawberry Pepper (Red) Seasoning

(1) A strawberry fermented solution was prepared by fermenting a mixture mixed with 69 wt % of washed Nonsan strawberries, 30 wt % of sugar, and 1 wt % of sea salt based on the total weight of the mixture in a pot at 20 to 30° C. for 30 days, filtering the mixture, and then aging at 12 to 17° C. for 1 year.

(2) A radish fermented solution was prepared by fermenting a mixture mixed with 59 wt % of crushed radish, 35 wt % of sugar, 5 wt % of sea salt, 0.5 wt % of citric acid, and 0.5 wt % of pine needles based on the total weight of the mixture in a pot at 20 to 30° C. for 90 days, and then filtering the mixture.

(3) An onion fermented solution was prepared by fermenting a mixture mixed with 63.2 wt % of chopped onion, 33 wt % of sugar, 3 wt % of sea salt, and 0.8 wt % of lime juice based on the total weight of the mixture in a pot at 20 to 30° C. for 60 days, and then filtering the mixture.

(4) A strawberry mixed fermented solution was prepared by mixing the strawberry fermented solution prepared in step (1), the radish fermented solution prepared in step (2), and the onion fermented solution prepared in step (3) at a weight ratio of 4:5:1.

(5) Domestic rice flour was sprayed with about 15 to 20% (v/w) of water based on rice flour, kneaded, and then molded into a round shape with a diameter of 5 to 15 cm. Malted rice was prepared by spreading rice straw in a fermentation chamber, spreading naturally dried raspberry leaves and vitamin tree leaves in sequence thereon, putting the molded rice paste on the vitamin tree leaves and covering a cotton cloth thereon, fermenting the rice paste at 30° C. for 7 days while turning over once a day, drying in the shade at 20 to 25° C. for 3 days, sweeping clearly, crushing, molding in the sunlight for about 3 to 4 days, and then pulverizing the rice paste.

(6) Domestic garlic was peeled, washed thoroughly, put on a sieve of a steamer, heated at 100° C. for 10 to 15 minutes, taken out, and grinded with a blender to prepare a garlic pulverized product.

(7) An anchovy sauce was prepared by purchasing anchovies from Hongwon Port and nearby seas in Seocheon, first aging an anchovy mixture with a salinity of about 20 to 25% mixed with sea salt without salt in an aging tank at 20 to 25° C. for 36 months or more, and then extracting only the liquid, and second aging and precipitating the anchovy liquid at 5° C. for 6 months.

(8) Rice syrup of 65 brix was prepared by adding 100 g of malt and 2.6 L of water to rice cooked with 1 kg of rice, saccharifying at 55 to 60° C. for 9 hours and filtering the mixture, and then adding 1% (w/v) of fig leaf powder and 1% (w/v) of savory powder based on the saccharification solution to the filtered saccharification solution, and boiling the mixture at 95° C.

(9) A strawberry pulverized product was prepared by aging the strawberry mixture mixed with 25 parts by weight of the strawberry mixed fermented solution prepared in step (4), 8 parts by weight of the malted rice prepared in step (5), 8 parts by weight of the garlic pulverized product prepared in step (6), 20 parts by weight of the anchovy sauce prepared in step (7), and 18 parts by weight of the rice syrup prepared in step (8) in a fermentation tank at 20 to 30° C. for 3 months, and then freeze-drying and pulverizing the mixture.

(10) Domestic red pepper powder, basil powder and black pepper powder were mixed with the strawberry pulverized product prepared in step (9) at a weight ratio of 79:19:1:1.

### Comparative Example 1. Strawberry Pepper (Red) Seasoning

(1) A strawberry fermented solution was prepared by fermenting a mixture mixed with 69 wt % of washed Nonsan strawberries, 30 wt % of sugar, and 1 wt % of sea salt based on the total weight of the mixture in a pot at 20 to 30° C. for 30 days, filtering the mixture, and then aging at 12 to 17° C. for 1 year.

(2) Domestic rice flour was sprayed with about 15 to 20% (v/w) of water based on rice flour, kneaded, and then molded into a round shape with a diameter of 5 to 15 cm. Malted rice was prepared by spreading rice straw in a fermentation chamber, putting the molded rice paste thereon and covering a cotton cloth thereon, fermenting the rice paste at 30° C. for 7 days while turning over once a day, drying in the shade at 20 to 25° C. for 3 days, sweeping clearly, crushing, molding in the sunlight for about 3 to 4 days, and then pulverizing the rice paste.

(3) Domestic garlic was peeled, washed thoroughly, put on a sieve of a steamer, heated at 100° C. for 10 to 15 minutes, taken out, and grinded with a blender to prepare a garlic pulverized product.

(4) An anchovy sauce was prepared by purchasing anchovies from Hongwon Port and nearby seas in Seocheon, first aging an anchovy mixture with a salinity of about 20 to 25% mixed with sea salt without salt in an aging tank at 20 to 25° C. for 36 months or more, and then extracting only the liquid, and second aging and precipitating the anchovy liquid at 5° C. for 7 months.

(5) Rice syrup of 65 brix was prepared by adding 100 g of malt and 2.6 L of water to rice cooked with 1 kg of rice, saccharifying at 55 to 60° C. for 9 hours and filtering the mixture, and then boiling the filtered saccharification solution at 95° C.

(6) A strawberry pulverized product was prepared by aging the strawberry mixture mixed with 25 parts by weight of the strawberry mixed fermented solution prepared in step (1), 8 parts by weight of the malted rice prepared in step (2), 8 parts by weight of the garlic pulverized product prepared in step (3), 20 parts by weight of the anchovy sauce prepared in step (4), and 18 parts by weight of the rice syrup prepared in step (5) in a fermentation tank at 20 to 30° C. for 3 months, and then freeze-drying and pulverizing the mixture.

(7) Domestic red pepper powder was mixed with the strawberry pulverized product prepared in step (6) at a weight ratio of 79:21.

### Comparative Example 2. Strawberry Pepper (Red) Seasoning

(1) A strawberry fermented solution was prepared by fermenting a mixture mixed with 69 wt % of washed Nonsan strawberries, 30 wt % of sugar, and 1 wt % of sea salt based on the total weight of the mixture in a pot at 20 to 30° C. for 30 days, filtering the mixture, and then aging at 12 to 17° C. for 1 year.

(2) A radish fermented solution was prepared by fermenting a mixture mixed with 60 wt % of crushed radish, 35 wt % of sugar, and 5 wt % of sea salt, based on the total weight of the mixture in a pot at 20 to 30° C. for 90 days, and then filtering the mixture.

(3) An onion fermented solution was prepared by fermenting a mixture mixed with 64 wt % of chopped onion, 33 wt % of sugar, and 3 wt % of sea salt, based on the total weight of the mixture in a pot at 20 to 30° C. for 60 days, and then filtering the mixture.

(4) A strawberry mixed fermented solution was prepared in the same method as steps (5) to (10) of Preparation Example 1 using the strawberry fermented solution prepared in step (1), the radish fermented solution prepared in step (2), and the onion fermented solution prepared in step (3).

### Example 1. Sensory Test of Strawberry Pepper Seasoning According to Material Type

The sensory test was performed on salads with strawberry pepper seasonings of Preparation Examples 1 and 2 and Comparative Examples 1 and 2, and the taste and preference for the strawberry pepper seasonings were tested by a 5-point scoring method targeting 30 sensory testers in their 30 s and 50 s: 1: very bad, 2: bad, 3: Normal, 4: good, 5: Very good. Each seasoning was evenly squeezed on a salad containing 30 g of lettuce and 70 g of chopped boiled chicken breast, and then the flavor, taste, and overall preference were evaluated.

TABLE 1
Sensory test of strawberry pepper seasoning

| Classification | Flavor | Taste | Overall preference |
|---|---|---|---|
| Preparation Example 1 | 4.0 | 4.1 | 4.2 |
| Preparation Example 2 | 4.1 | 4.4 | 4.5 |
| Comparative Example 1 | 3.5 | 3.5 | 3.4 |
| Comparative Example 2 | 3.6 | 3.8 | 3.7 |

As a result, the salads squeezed with the strawberry pepper seasonings of Preparation Examples 1 and 2 showed higher scores in taste, flavor, and overall preference than the salads squeezed with the strawberry pepper seasonings of Comparative Examples, and particularly, the strawberry pepper seasoning of Preparation Example 2 showed the highest preference.

1. A method for producing a strawberry pepper seasoning comprising the steps of:
(1) preparing a strawberry fermented solution by fermenting a mixture of strawberries with sugar and salt, and then filtering and aging the mixture;
(2) preparing a radish fermented solution by fermenting a mixture of radish with sugar, salt, citric acid, and pine needles, and then filtering the mixture;
(3) preparing an onion fermented solution by fermenting a mixture of onion with sugar, salt, and lime juice, and then filtering the mixture;
(4) preparing a strawberry mixed fermented solution by mixing the strawberry fermented solution prepared in step (1), the radish fermented solution prepared in step (2), and the onion fermented solution prepared in step (3);
(5) preparing malted rice by spreading rice straw in a fermentation chamber, putting and fermenting rice paste thereon, and drying, pulverizing, and molding the rice paste;
(6) preparing a garlic pulverized product by putting and heating garlic in a steamer, and then pulverizing the garlic;
(7) preparing rice syrup by adding malt and water to rice cooked with rice, saccharifying and filtering the mixture, and then boiling a filtered saccharification solution;
(8) preparing a strawberry pulverized product by aging and then freeze-drying and pulverizing a strawberry mixture mixed with the strawberry mixed fermented solution prepared in step (4), the malted rice prepared in step (5), the garlic pulverized product prepared in step (6), the rice syrup prepared in step (7), and the anchovy sauce; and
(9) mixing red pepper powder, basil powder and black pepper powder with the strawberry pulverized product prepared in step (8).

2. The method for producing the strawberry pepper seasoning of claim 1, wherein the strawberry mixture of step (8) is a strawberry mixture mixed with 23 to 27 parts by weight of the strawberry mixed fermented solution, 7 to 9 parts by weight of the malted rice, 7 to 9 parts by weight of the garlic pulverized product, 18 to 22 parts by weight of the anchovy sauce, and 16 to 20 parts by weight of the rice syrup.

3. The method for producing the strawberry pepper seasoning of claim 2, comprising the steps of:
(1) preparing a strawberry fermented solution by fermenting a mixture mixed with 67 to 71 wt % of strawberries, 28 to 32 wt % of sugar, and 0.5 to 1.5 wt % of salt based on the total weight of the mixture at 20 to 30° C. for 25 to 35 days, filtering the mixture, and then aging at 12 to 17° C.;
(2) preparing a radish fermented solution by fermenting a mixture mixed with 57 to 61 wt % of radish, 33 to 37 wt % of sugar, 4 to 6 wt % of salt, 0.3 to 0.7 wt % of citric acid, and 0.3 to 0.7 wt % of pine needles based on the total weight of the mixture at 20 to 30° C. for 80 to 100 days, and then filtering the mixture;
(3) preparing an onion fermented solution by fermenting a mixture mixed with 61 to 65 wt % of onion, 31 to 35 wt % of sugar, 2 to 4 wt % of salt, and 0.6 to 1.0 wt % of lime juice based on the total weight of the mixture at 20 to 30° C. for 50 to 70 days, and then filtering the mixture;
(4) preparing a strawberry mixed fermented solution by mixing the strawberry fermented solution prepared in step (1), the radish fermented solution prepared in step (2) and the onion fermented solution prepared in step (3) at a weight ratio of 3.5 to 4.5:4.5 to 5.5:0.5 to 1.5;
(5) preparing malted rice by spreading rice straw in a fermentation chamber, putting rice paste thereon, fermenting the rice paste at 28 to 32° C. for 6 to 8 days, drying at 20 to 25° C. for 2 to 4 days, and then pulverizing and molding the rice paste;
(6) preparing a garlic pulverized product by putting garlic in a steamer, heating at 95 to 105° C. for 10 to 15 minutes and then pulverizing the garlic;
(7) preparing rice syrup of 60 to 70 brix by adding 80 to 120 g of malt and 2.4 to 2.8 L of water to rice cooked with 0.8 to 1.2 kg of rice, saccharifying at 55 to 60° C. for 7 to 11 hours and filtering the mixture, and then boiling the filtered saccharification solution at 90 to 100° C.;
(8) preparing a strawberry pulverized product by aging the strawberry mixture mixed with 23 to 27 parts by weight of the strawberry mixed fermented solution prepared in step (4), 7 to 9 parts by weight of the malted rice prepared in step (5), 7 to 9 parts by weight of the garlic pulverized product prepared in step (6), 16 to 20 parts by weight of the rice syrup prepared in step (7), and 18 to 22 parts by weight of the anchovy sauce at 20 to 30° C. for 2 to 4 months, and then freeze-drying and pulverizing the mixture; and
(9) mixing red pepper powder, basil powder and black pepper powder with the strawberry pulverized product prepared in step (8) at a weigh ratio of 77 to 81:17 to 21:0.5 to 1.5:0.5 to 1.5.

4. The method for producing the strawberry pepper seasoning of claim 3, comprising the steps of:
(1) preparing a strawberry fermented solution by fermenting a mixture mixed with 67 to 71 wt % of strawberries, 28 to 32 wt % of sugar, and 0.5 to 1.5 wt % of salt based on the total weight of the mixture at 20 to 30° C. for 25 to 35 days, filtering the mixture, and then aging at 12 to 17° C.;
(2) preparing a radish fermented solution by fermenting a mixture mixed with 57 to 61 wt % of radish, 33 to 37 wt % of sugar, 4 to 6 wt % of salt, 0.3 to 0.7 wt % of citric acid, and 0.3 to 0.7 wt % of pine needles based on the total weight of the mixture at 20 to 30° C. for 80 to 100 days, and then filtering the mixture;
(3) preparing an onion fermented solution by fermenting a mixture mixed with 61 to 65 wt % of onion, 31 to 35 wt % of sugar, 2 to 4 wt % of salt, and 0.6 to 1.0 wt % of lime juice based on the total weight of the mixture at 20 to 30° C. for 50 to 70 days, and then filtering the mixture;
(4) preparing a strawberry mixed fermented solution by mixing the strawberry fermented solution prepared in step (1), the radish fermented solution prepared in step (2) and the onion fermented solution prepared in step (3) at a weight ratio of 3.5 to 4.5:4.5 to 5.5:0.5 to 1.5;
(5) preparing malted rice by spreading rice straw in a fermentation chamber, spreading raspberry leaves and vitamin tree leaves sequentially thereon, putting rice paste on the vitamin tree leaves, fermenting the rice paste at 28 to 32° C. for 6 to 8 days, drying at 20 to 25° C. for 2 to 4 days, and then pulverizing and molding the rice paste;
(6) preparing a garlic pulverized product by putting garlic in a steamer, heating at 95 to 105° C. for 10 to 15 minutes and then pulverizing the garlic;
(7) preparing rice syrup of 60 to 70 brix by adding 80 to 120 g of malt and 2.4 to 2.8 L of water to rice cooked with 0.8 to 1.2 kg of rice, saccharifying at 55 to 60° C. for 7 to 11 hours and filtering the mixture, and then adding 0.8 to 1.2% (w/v) of fig leaf powder and 0.8 to 1.2% (w/v) of savory powder based on the saccharification solution to the filtered saccharification solution, and boiling the mixture at 90 to 100° C.;
(8) preparing a strawberry pulverized product by aging the strawberry mixture mixed with 23 to 27 parts by weight of the strawberry mixed fermented solution prepared in step (4), 7 to 9 parts by weight of the malted rice prepared in step (5), 7 to 9 parts by weight of the garlic pulverized product prepared in step (6), 16 to 20 parts by weight of the rice syrup prepared in step (7), and 18 to 22 parts by weight of the anchovy sauce at 20 to 30° C. for 2 to 4 months, and then freeze-drying and pulverizing the mixture; and
(9) mixing red pepper powder, basil powder and black pepper powder with the strawberry pulverized product prepared in step (8) at a weigh ratio of 77 to 81:17 to 21:0.5 to 1.5:0.5 to 1.5.

5. A strawberry pepper seasoning produced by the method of claim 1.

6. A strawberry pepper seasoning produced by the method of claim 2.

7. A strawberry pepper seasoning produced by the method of claim 3.

8. A strawberry pepper seasoning produced by the method of claim 4.
